(19) United States
(12) Patent Application Publication
(10) Pub. No.: US 2002/0198004 A1
(43) Pub. Date: Dec. 26, 2002

(54) Method and apparatus for adjusting functions of an electronic device based on location

(76) Inventors: Anders Heie, San Diego, CA (US); Bill Nimmo, San Diego, CA (US); Dandi Lynde-Redman, San Diego, CA (US)

Correspondence Address: Brian Rivers, Patent Department, % Milan Patel, Nokia Mobile Phones, 6000 Connection Drive, Irving, TX, 75039, US

(21) Appl. No.: 09/885,849

(22) Filed: Jun. 20, 2001

(51) Int. Cl. H04Q 7/20

(52) U.S. Cl. 455/456; 455/12.1

(57) ABSTRACT

The present invention encompasses an electronic device operated in a communication system (for example CDMA, TDMA, GSM, etc.). The electronic device receiving location information from external resources. The electronic device uses the location information to determine the current location. Upon determining current location, the electronic device modifies the operations of the electronic device based on the current location, for example, turning off transmitting operations in a hospital zone.

### FIELD OF THE INVENTION

This invention relates to a method and apparatus for adjusting functions of an electronic device, more particularly, to a method and apparatus of automatically adjusting functions of an electronic device based on the location of the electronic device.

### BACKGROUND OF THE INVENTION

A wireless communication system is a communication system in which information is communicated between a transmitting and a receiving station via one or more base stations. A cellular or digital communication system is exemplary of a multi-user wireless communication system and a mobile station is one such example of the transmitting and receiving station.

Mobile stations (also known as radiotelephones, mobile devices, mobile transceivers, mobile telephones, mobile terminals, personal digital assistants, etc.) are becoming a convenient means of communication around the world. People use mobile phones as a main means of communication throughout everyday life. People use mobile phones to take care of everyday business or take care of personal matters from anywhere in the world.

The number of mobile station users is increasing, as mobile stations are becoming a popular and convenient electronic device. To stay connected people carry their mobile station everywhere they go. To stay connected, people carry their phones while shopping, while at work, while in restaurants and theaters. However, there are locations where a user is not allowed to use the mobile station (for example hospitals and medical clinics) or it is inappropriate (for example theaters and restaurants). Therefore, the user must manually adjust the functions of the mobile station when they are in those locations where use of the mobile station is not allowed or inappropriate. At some locations, the user may have to modify the profiles based on audio or visual conditions at a given location, such as a ballpark or in a noisy public area. The problem is that the majority of the users forget to change the functions of the mobile station upon their arrival and departure at the above mentioned locations. Therefore, this leads to unnecessary missed calls or the mobile station generating an audio alert at an undesirable location, such as ringing during a movie or a theater play.

It would be useful if a method was provided that automatically adjusted one or more functions of the mobile station based on the location of the mobile station.

### SUMMARY OF THE INVENTION

The present invention advantageously provides an apparatus and an associated method, for an electronic device to automatically adjust one or more functions of the electronic device.

The present invention encompasses an electronic device, such as a mobile terminal, a mobile station, a personal digital assistant (PDA) or a computer, which may be operated in a communication system (for example CDMA, TDMA, GSM, etc.). The electronic device comprises a method that adjusts the functions of the mobile station based on the current location of the electronic device. The electronic device comprises a method that may periodically determine if the electronic device is in a predefined zone, which requires a change in one or more functions of the electronic device, such as a change in a profile. The method may automatically change the profile of the electronic device to vibrate mode if determined that the electronic device is in a zone defined to require changing the profile to vibrate mode, such as in a theater.

Additionally, the method allows the user to provide location parameters to establish one or more zones and the actions required to be performed if the electronic device enters at least one of the established zones. The method may allow the user to retrieve the zone parameters from an external database or allow the user to create a zone. The user may also visit the actual location, for example a hospital, to determine the zone. Upon defining the zone parameters for a particular location, the zone parameters may be stored in memory. The zone parameters may be stored in memory and associated with one or more sectors for quicker access when determining if the electronic device is in a predefined zone.

A more complete appreciation of all the advantages and scope of the present invention can be obtained from the accompanying drawings, the following detailed description of the invention, and the appended claims.

### BRIEF DESCRIPTION OF THE DRAWINGS

FIG. 1 illustrates a block diagram of a mobile terminal into which an embodiment of the invention may be implemented;

FIG. 2 shows an exemplary geographical region in which the mobile terminal is operated;

FIG. 3 shows a zone setup task software module depiction of an embodiment of the invention.

FIG. 4 shows a zone monitoring task software module depiction of an embodiment of the invention;

### DETAILED DESCRIPTION OF THE INVENTION

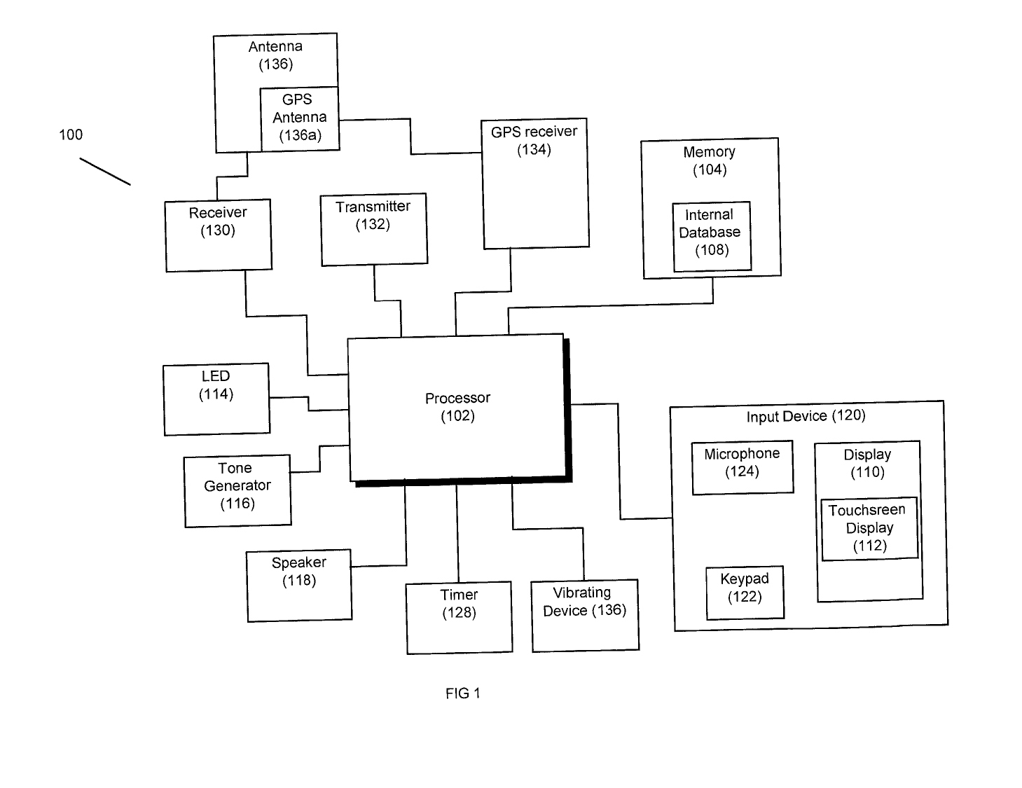

FIG. 1 is a block diagram of the electronic device, such as a mobile terminal 100, according to an embodiment of the invention. The mobile terminal 100 is operable in a wireless communication system (for example CDMA, TDMA, GSM, etc.). Generally, the mobile terminal 100 includes a controller 102 (which may also be known as a processor 102) coupled to various memories, collectively shown as memory 104. Memory 104 includes a plurality of stored constants and variables that are used by processor 102 during the operation of the electronic device 100. For example, memory 104 stores the values of the various feature parameters and the Number Assignment Module (NAM). The memory 104 also comprises an internal database 108, for storing position parameters, profile settings of the electronic device, zone parameters and sector information. An operating program for controlling the operation of processor 102 is also stored in memory 104 (typically in a read only memory). Memory 104 is also used to store data provided by the user through the user interface. Furthermore, memory 104 is used to hold the subprograms or sub-processes for controlling the operation of mobile terminal 100 and carrying out the embodiment of the invention. The operating program in memory 104 includes routines for automatically adjusting functions of the mobile terminal 100.

The user interface of the mobile terminal 100 also includes a Liquid Crystal Display (LCD) 110, a touch-screen display 112, Light Emitting Diode (LED) 114, tone generator 116, speaker 118 and user input device 120, comprising an alpha-numeric keypad 122, all of which are coupled to processor 102. The input device 120 may also comprise microphone 124, for generating input, and a touch screen display 112. Mobile terminal 100 also comprises timer 128 (also referred to as a clock chip) coupled to processor 102 for synchronizing the operations of processor 102 and tracking time.

The exemplary mobile terminal 100 also includes a receiver 130 coupled to an antenna 136 for receiving incoming signals, and a transmitter 132 for transmitting outgoing signals, both are coupled to the processor 102. The processor 102, coupled to the transmitter 132 and the receiver 130, initiates the transmission of outgoing signals and processes incoming signals, respectively. These signals may include signaling information in accordance with the air interface of the applicable cellular or digital system and also user speech and/or user generated data. The outgoing signals may be used to request data from external databases and the incoming signals may include position information and geographical zone parameters.

In an embodiment, the mobile terminal 100 comprises a Global Positioning System (GPS) receiver 134 for receiving GPS signals from one or more navigational satellites. The GPS receiver 134 is coupled to the processor 102, the processor 102 for processing GPS signals to calculate the location of the mobile terminal 100. The GPS signals are transmitted to the surface by orbiting GPS satellites (preferably three or more), that are picked up by a GPS antenna 136a, which may be integrated into the antenna 136. The GPS receiver 134 converts the GPS signals received from the GPS orbiting satellites into the spatial coordinates of the current receiver location. The spatial coordinates may be defined by the four coordinates x, y, z and t, with x, y, z being the three dimensional spatial point and t being the time at which the x, y, z spatial reference occurs. By simple geometry, for example triangulation, the position of the mobile terminal 100 in latitude and longitude may be calculated. The use of triangulation to determine position is well known and one of ordinary skill in the art will recognize that use of GPS signals will produce a very accurate fix on the GPS receiver's 134 location. Using the spatial coordinates determined from base stations or GPS satellites and using well-known triangulation techniques the processor 102 is able to generate the location (or position) of the mobile terminal 100.

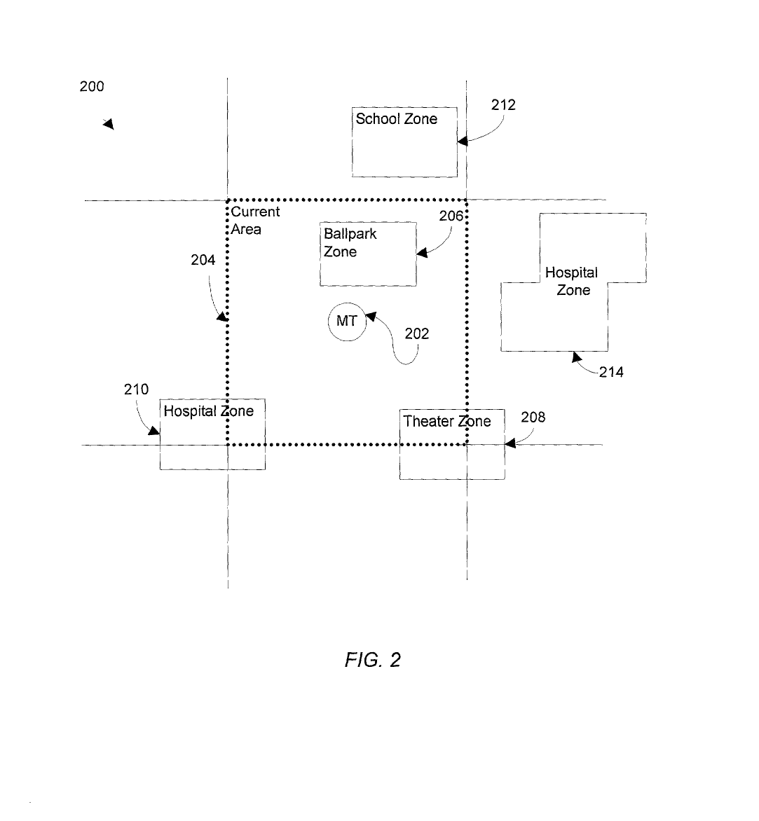

FIG. 2A shows an exemplary geographical region 200 defined by plurality of sectors and plurality of predetermined zones. Each of the zones, a ballpark zone 206, a theater zone 208, a hospital zone 210, a school zone 212 and hospital zone 214, are defined by zone parameters that are stored in memory 104 of the mobile terminal 100. Each zone is associated with at least one sector, analogous to sector 204. The exemplary geographical region is defined by plurality of adjacent sectors, wherein the sector boundary parameters may vary based on use preference and a preferred method of storing zone parameters. A zone is associated with a sector if any portion of the zone is a sector. Some zones may be associated with more than one sector and some sectors may not have any zones. In the exemplary geographical region, the current sector 204 associated with the current location 202 of mobile terminal 100, comprises the ballpark zone 206, the hospital zone 214 and theater zone 208.

In an operation of the invention, the mobile terminal 100 determines the current sector upon determining the mobile terminal's position 202. There are several well-known techniques used to determine the current sector. One such technique is comparing the current location parameters against the sector parameters stored in memory 104. Upon determining the current sector 204, the processor 102 generates a current sector zone list comprising any and all the zones associated with the current sector. In the exemplary geographical region, the current sector zone list for current sector 204 comprises the ballpark zone 206, the hospital zone 214 and theater zone 208. Upon generating the current sector zone list, the processor 102 determines that if the current location is within at least one of the zones of the current sector zone list, then the processor 102 adjusts the function of the mobile terminal 100 according to the actions assigned for the zone. It should be noted that not all the sectors have a predetermined zone associated with it and that the processor 102 may adjust the timing of calculating the location if the current location is in a sector that does not have any predetermined zones.

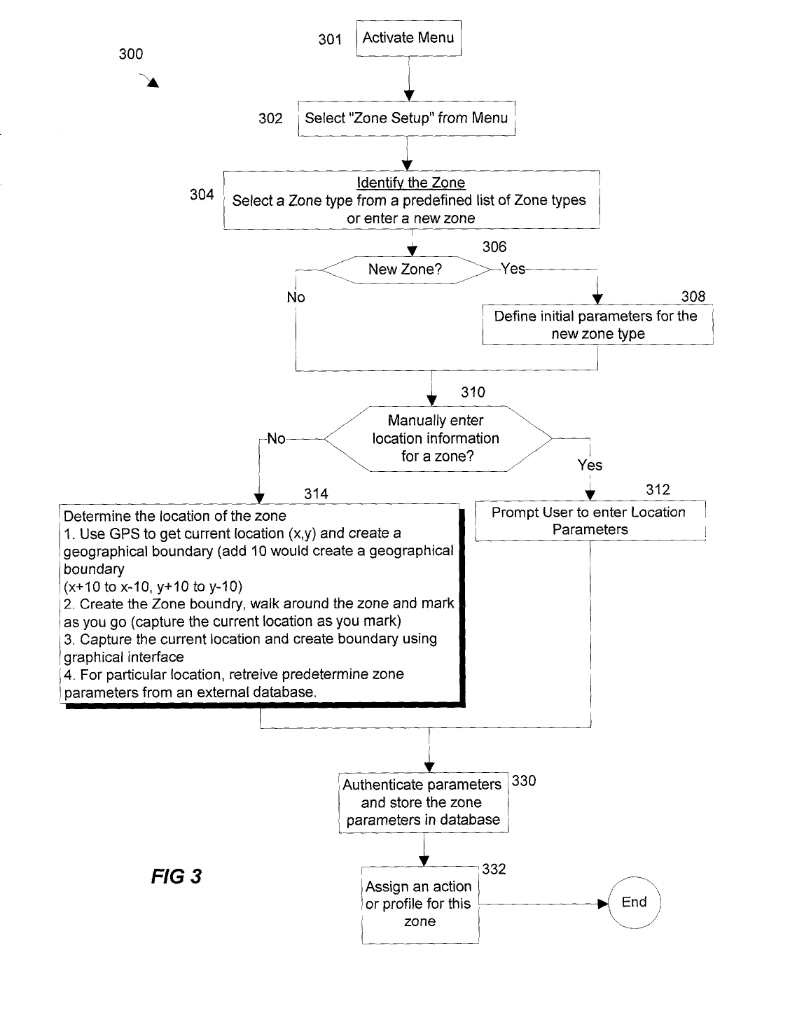

Referring now to FIG. 3, which describes a zone setup task accordance to an embodiment of the invention. The zone setup task is initiated, at block 301, upon the activation of the menu feature of the mobile terminal 100. At block 302, “Zone Setup” is selected from the menu. At block 304, the type of zone is identified. The user may either select from a predefined type of zones, for example “Theater” or create new type. At block 306, determine if the user has selected a new zone type, then at block 308 define initial parameters for the new zone, for example, a name of the zone. Regardless of the whether user elects to add a new zone type or modify a pre-existing zone type, at block 310, the user is prompted to enter the location information manually. If the user elects to manually provide the location parameters, then at block 312, the user is prompted to provide the location parameters. Referring back to block 310, If the user elects not to manually provide the location parameters, then at block 314, the user is prompted to choose a method of determining location parameters. The preferred method is to use the GPS receiver to determine location and add predetermined values to parameters to define a zone boundary. An exact boundary may be determined by using location calculation methods and marking the zone. Another method is to determine the current location and use a graphical user interface to define a zone boundary. If the mobile terminal 100 is connected to the Internet or a computer, then the user can download the zone boundaries from an external database. For example, in the future, all hospitals may have zone boundaries available in a database, which may be downloaded without the user having to determine the zone boundary (location parameters).

Upon authenticating the parameters, at block 330, the zone parameters are stored in an internal database 108 of memory 104. Additionally, one or more sector is associated with the new zone using the zone parameters. At block 332, the user may assign one or more action to the zone. These actions are used to adjust the functions of the mobile terminal 100. In an embodiment of the invention, the zone parameters, the association of the zone parameters to sectors and action assignments for one or more zone may be stored in an external database.

Generally, the type of action is selected from an action list comprising plurality of action types. For example, the action list may comprise a change to silent profile action, a change to default profile action, a change to theater profile action, a change to hospital profile action and a change to stadium action. Generally, the change to silent profile action comprises an act by the processor 102 to change the profile of the electronic device to a silent mode, whereby the audio function is not used to provide alerts of any incoming calls. The change to theater profile action comprises an act by the processor 102 to change the profile of the electronic device to a meeting mode, whereby a visual or other functions (for example vibration) are used to provide alerts of incoming calls instead of the audio function. The change to default profile action comprises a change of operation of all functions to preset default modes. The change to hospital profile action comprises an act by the processor 102 to turn off all transmitting functions, such as the transmitter 132, whereby either mobile terminal 100 is powered off or only the portion of the functions are turn off. For example, phonebook function may continue to function while all the RF components are turned off. The change to stadium action comprises an act by the processor 102 to change the profile of the electronic device to provide a louder alert, whereby the volume of the audio alert is increased. Also the speaker's 118 volume increased to compensate for noisy surrounding. It should be noted that manufactures may provide additional action types at the time of manufacture or the user may create additional action types based on user preference. The user may also set a delay, which would indicate to the processor 102 to perform the required action after waiting for a period of time, for example the turns of all the transmitting functions after a delay.

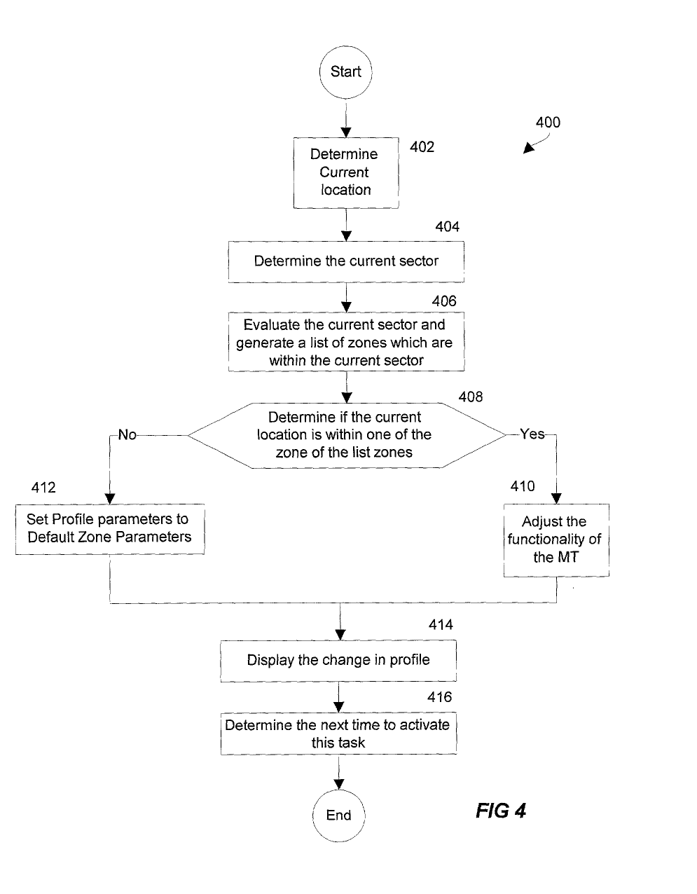

Referring now to FIG. 4, which describes a zone monitoring task 400 accordance to a preferred embodiment of the invention for monitoring the location of the mobile terminal 100. The zone-monitoring task 400 is initiated periodically or upon user activation. The activation period may be determined at the time of manufacture or based on previous location information, for example when determined that current sector does have any predetermined zones.

Upon the activation of a zone-monitoring task 400, at block 402 the processor 102 determines a current location of the mobile terminal 100. In the preferred embodiment, the processor 102 uses the GPS receiver and well-known techniques to determine the location in terms of two dimension (for example latitude and longitude). Other location determining techniques may be used, for example a well-known triangulation techniques, to determine the location without departing from the invention. At block 404, the processor 102 accessing internal database 108 or an external database (not shown) determines the current sector based on the current location. According to an embodiment of the invention, in the internal or external database, a two dimensional array is used to define the sectors. The two-dimensional (X, Y) is used to store sector information, wherein each “X” and “Y” represents an sector address value, which used to access a sector number or sector information. The address value may be a latitude range and Y may be a longitude range. For example, at (X=1, Y=2) address in the two-dimensional array, sector information for latitude=1000 and longitude=2000 is stored in memory 104. Other well-known techniques may be used in determining the current sector without departing from the invention.

Upon determining the current sector parameters, either the sector address values or the sector number, at block 406, the processor 102 evaluates the current sector to determine if there are any pre-defined zones within the current sector. If yes, then the processor 102 generates a list of zones (a zone list) associated with the current sector. It should be noted that there might not be any zones associated with the current sector. At block 408, the processor 102 determines if the current location is within any zones of the zone list. For a sector that does not have any associated zones, as a default, the processor 102 considers that the current location is not within any zones of the current sector and executes the block 412. At block 412, the change to default profile is executed to set mobile terminal's 100 functions to default settings. Otherwise, if the current location is within at least one zone of the zone list, then at block 410 the processor 102 executes the action based on action assigned to the zone. If the action is to turn off the certain features or the mobile terminal 100, then a warning may be provided before the action is carried out. This will allow the user to override the action. If no override is performed by the user, then at block 414, the processor 102 displays a message indicating that certain functions have been changed and displays the current profile of the mobile terminal 100. At block 416, the process determines the next time to activate the zone-monitoring task 400. In the case where there were no zones defined, the processor 102 may add a delay in the periodic activation of the zone-monitoring task 400 to avoid unnecessary processing. This delay may be cleared if a new zone is added in the current sector.

While the invention has been particularly shown and described with reference to a preferred embodiment, it will be understood by those skilled in the art that various changes in form and details may be made therein without departing from the spirit and scope of the invention as defined by the appended claims. That is, other modifications and variations to the invention will be apparent to those skilled in the art from the foregoing disclosure and teachings.

Thus, while only certain embodiments of the invention have been specifically described herein, it will be apparent that numerous modifications may be made thereto without departing from the spirit and scope of the invention.

What is claimed is:

1. A method for adjusting functions of an electronic device based on location of the electronic device, the method comprising the steps of:
determining a current location of the electronic device;
determining a current sector associated with said current location;
evaluating said current sector to determine if one or more zone is associated with said current sector; and
executing an action to adjust a function of the electronic device if determined that at least one said zone is associated with said current sector and said current location is within at least one said zone.

2. The method as claimed in claim 1, wherein the step of evaluating comprises a step of defining parameters for at least one said zone.

3. The method as claimed in claim 2, wherein the step of defining said parameters for at least one said zone comprises a step of associating said zone to one or more sectors.

4. The method as claimed in claim 3, wherein the step of defining said parameters for at least one said zone comprises a step of retrieving said parameters from an external database.

5. The method as claimed in claim 3, wherein the step of defining said parameters for at least one said zone comprises a step of receiving said parameters in a said electronic device from a user of said electronic device.

6. The method as claimed in claim 1, wherein the step of executing said action comprises the step of turning off one or more transmitting functions of the electronic device.

7. The method as claimed in claim 6, wherein the step of turning off the said transmitting functions of the electronic device comprises the step of turning off the said transmitting functions after a delay.

8. The method as claimed in claim 1, wherein the step of executing said action comprises the step of changing profile setting of the electronic device to provide visual alert or vibrate alert without audio alert.

9. The method as claimed in claim 1, wherein the step of executing said action comprises the step of increasing volume of an audio alert and volume of a speaker.

10. The method as claimed in claim 1, wherein the step of executing comprises the step of changing operation of all functions to preset default modes if determined that said current location is not within at least one said zone.

11. An electronic device operated in a wireless communication system, the electronic device comprising:
a processor for determining a current position of the electronic device; said processor further determining a current sector associated with said current location; said processor further evaluating said current sector to determine if one or more zone is associated with said current sector and executing an action to adjust a function of the electronic device if determined that at least one said zone is associated with said current sector and said current location is within at least one said zone.

12. The electronic device as claimed in claim 11, further comprises:
a database coupled to said processor;
said processor further for defining parameters for at least one said zone and storing parameters in said database.

13. The electronic device as claimed in claim 12, wherein said processor further for associating said zone to one or more sectors.

14. The electronic device as claimed in claim 12, wherein said processor for retrieving said parameters from an external database.

15. The electronic device as claimed in claim 12, further comprises:
an input device coupled to said processor; said input device for allowing user to define said parameters for at least one said zone; and
said processor further for storing said parameters received from the user through said input device into said memory.

16. The electronic device as claimed in claim 11, wherein said action comprises a change to silent profile action, a change to default profile action, a change to theater profile action, a change to hospital profile action and a change to stadium action.

17. In a wireless communication system in which an electronic device is receiving location information from at least one satellite, a method for adjusting functions of the electronic device, comprising the acts of:
determining a current location of the electronic device using the location information;
evaluating said current location to determine if said current location is within at least one pre-defined zone; and
executing an action to adjust one or more functions of the electronic device if determined that said current location is within said at least one pre-defined zone.

18. The method of claim 17, wherein the act of executing said action comprises the act of turning off one or more transmitting functions of the electronic device.

19. The method of claim 17, wherein the act of evaluating said current location comprises the act of defining parameters for at least one said zone and storing said parameters in a database.

20. The method of claim 17, wherein said act of executing comprises the act of changing operation of all functions to preset default modes if determined that said current location is not within said at least one pre-defined zone.
